(19) United States
(12) Patent Application Publication
(10) Pub. No.: US 2022/0153387 A1
(43) Pub. Date: May 19, 2022

(54) Pneumatic Assist Device for a Bicycle

(71) Applicant: Gabriel Hernandez, Beloit, WI (US)

(72) Inventor: Gabriel Hernandez, Beloit, WI (US)

(21) Appl. No.: 17/519,678

(22) Filed: Nov. 5, 2021

Related U.S. Application Data
(60) Provisional application No. 63/113,494, filed on Nov. 13, 2020.

(51) Int. Cl. B62M 6/80

(52) U.S. Cl. CPC B62M 6/80

(57) ABSTRACT

The present invention relates to an apparatus for providing a pneumatic assist device for a bicycle, wheelchair or other wheeled device. The pneumatic assist device is configured for providing bionic assistance using a pneumatic system. The device further comprises a ball-bearing gear box, a plurality of gears, a bionic assist component, and a pedal assembly. Further, an assist arm engages a gear inside the gear box, and the bionic assist component attaches to a wheel lock, then the pedal assembly has a pump providing pneumatic pressure for a smooth bicycle ride. A plurality of guides align the gears of the gearbox, and a plurality of elastic bands also engage ball-bearings of the gearbox.

### CROSS-REFERENCE TO RELATED APPLICATION

The present application claims priority to, and the benefit of, U.S. Provisional Application No. 63/113,494, which was filed on Nov. 13, 2020 and is incorporated herein by reference in its entirety.

### FIELD OF THE INVENTION

The present invention relates generally to the field of bicycles. More specifically, the present invention relates to an apparatus for providing power to a bicycle. The bicycle powering apparatus is configured for providing pneumatic assistance to riders for a more pleasant ride. The apparatus includes a ball-bearing gear box, gears, strong rubber bands, an assist arm, a bionic assist component that attaches to the wheel lock and a pedal and housing unit. The apparatus provides pressurized air to assist a rider such that the rider does not need to continuously pedal using the two standard pedals. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, bicycling is an increasingly popular form of recreation and means of transportation. In addition, bicycling has become a popular competitive sport for both amateurs and professionals. Therefore, in order to fulfill the needs and requirements of different users, the bicycle industry is constantly improving various components of the bicycle.

Generally, riding a conventional bicycle requires a substantial amount of energy, force and stamina, wherein a rider is required to continuously pedal to keep the bicycle moving unless he or she is coasting. This constant pedaling motion can further be very taxing on the body, and many do not find it to be a relaxing or enjoyable. As a result, some riders may not enjoy the overall cycling experience. This is especially true when cycling for long distances, as a rider may tire and require frequent breaks to reach their destination.

Therefore, there exists a long-felt need in the art for a bicycle that can be conveniently ridden by all users. There is also a long-felt need in the art for a bicycle that ensures a pleasant riding experience for riders. Additionally, there is a long-felt need in the art for a bicycle that does not require a user to continuously pedal the bicycle to keep it in motion. Moreover, there is a long felt need in the art for a bicycle that uses a mechanism to help reduce the effort needed to keep the bicycle moving. Further, there is a long-felt need in the art for a bicycle that ensures that the pedaling motion is not taxing for riders. Furthermore, there is a long-felt need in the art for an improved bicycle that allows users to cover long distances without getting tired or taking frequent breaks. Finally, there is a long felt need in the art for a bicycle that ensures that the users enjoy their cycling experience.

The subject matter disclosed and claimed herein, in one embodiment thereof, comprises a pneumatic assist device for bicycles. The device is configured to provide bionic assistance to a rider of a bicycle. More specifically, the device includes a ball-bearing gear box, a plurality of gears, a bionic assist component and a pedal assembly. Further, an assist arm engages a gear inside the ball-bearing gear box and the bionic assist component attaches to a front wheel, wherein the pedal assembly controls the pneumatic pressure for a smooth bicycle ride. A plurality of guides also align the gears of the ball-bearing gearbox, and a plurality of elastic bands also engage the ball-bearings of the gearbox.

In this manner, the novel pneumatic assist device of the present invention accomplishes all of the forgoing objectives, and provides a relatively safe, easy and convenient bicycle ride. Further, the device eliminates the continuous need of pedaling the bicycle and provides pneumatic and bionic assistance to the rider. In turn, the device then provides a more enjoyable cycling experience for the rider.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pneumatic assist device for bicycles. The pneumatic assist device is configured to provide bionic assistance to a rider of a bicycle, and is comprised of a ball-bearing gear box, a plurality of gears, a bionic assist component and a pedal assembly. Further, an assist arm engages a gear inside the gear box, and the bionic assist component attaches to a front wheel, wherein motion of the pedals builds up air pressure in a pneumatic pump which releases the air pressure once the pneumatic assist device is engaged to propel the front wheel faster. A plurality of guides also align the gears of the gearbox, and a plurality of elastic bands engage ball-bearings of the gearbox. Accordingly, the plurality of guides and the plurality of elastic bands act to shift the gears driving the pneumatic assist device to build air pressure when a user is pedaling, and releases the pressure when a user activates the pneumatic assist device which powers the front wheel.

In a further embodiment of the present invention, the device is comprised of a lever and a release button on the handlebar of the bicycle the device is applied to, and is connected to the gearbox and pedal assembly through a cable, thereby allowing easy activation of the pneumatic assist device for bicycles. In yet a further embodiment, the device is comprised of a bicycle power supply that contains a lever and a release button configuration that attaches to a handlebar of a bicycle, a ball-bearing gearbox that attaches to the inside of the bicycle front wheel, a plurality of gears, an assist arm that engages a gear inside the gear box, a bionic assist component that attaches to the front wheel and a pedal assembly controlling a pneumatic pump. Finally, in another additional embodiment of the present invention, a plurality of guides align the gears of the gearbox, and a plurality of elastic bands engage the ball-bearings of the gearbox.

Accordingly, the pneumatic assist device for bicycles of the present invention is extremely advantageous and provides a pneumatic assist for bicycles to allow for a more pleasant ride. Further, the device eliminates the need for a rider to constantly pedal via the two standard pedals. As a result, a rider can now travel much longer distances without fatiguing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the pneumatic assist device for a bicycle of the present invention in accordance with the disclosed architecture;

FIG. 2 illustrates a top perspective view of one potential embodiment of the swivels used for securing the pedal bionic assist component in the pneumatic assist device of the present invention in accordance with the disclosed architecture;

FIG. 3 illustrates a side perspective view of a bicycle having one potential embodiment of the pneumatic assist device of the present invention attached to the front wheel of the bicycle in accordance with the disclosed architecture; and

FIG. 4 illustrates a perspective view of a small gear used in one potential embodiment of the pneumatic assist device and gear box of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a bicycle that can be conveniently used by all riders. There is also a long-felt need in the art for a bicycle that ensures a pleasant ride for all riders and does not require a rider to continuously pedal to propel the bicycle. Moreover, there is a long-felt need in the art for a bicycle that uses a mechanism to help ease the effort required by a rider to keep the bicycle moving and ensures that the pedaling motion is not taxing on a user. Furthermore, there is a long-felt need in the art for an improved bicycle that allows users to cover long distances without fatiguing or taking frequent breaks. Finally, there is a long-felt need in the art for a bicycle that ensures that riders enjoy their cycling experience.

The present invention, in one exemplary embodiment, is comprised of a pneumatic assist device for bicycles. The device in one embodiment is comprised of a lever and a release button configuration that attaches to a handlebar of a bicycle, a ball-bearing gearbox that attaches to the inside of the bicycle front wheel, a plurality of gears, an assist arm that engages a gear inside the gear box, a bionic assist component that attaches to the front wheel and a pedal assembly controlling a pneumatic pump. An additional embodiment may also be comprised of a pneumatic assist device that attaches to a front wheel of a bicycle and consists of a lever and release button on the handlebars connected with a bicycle cable to the gear box and pedal assembly. As a result, the device of the present invention provides a rider with a convenient and pleasant riding experience.

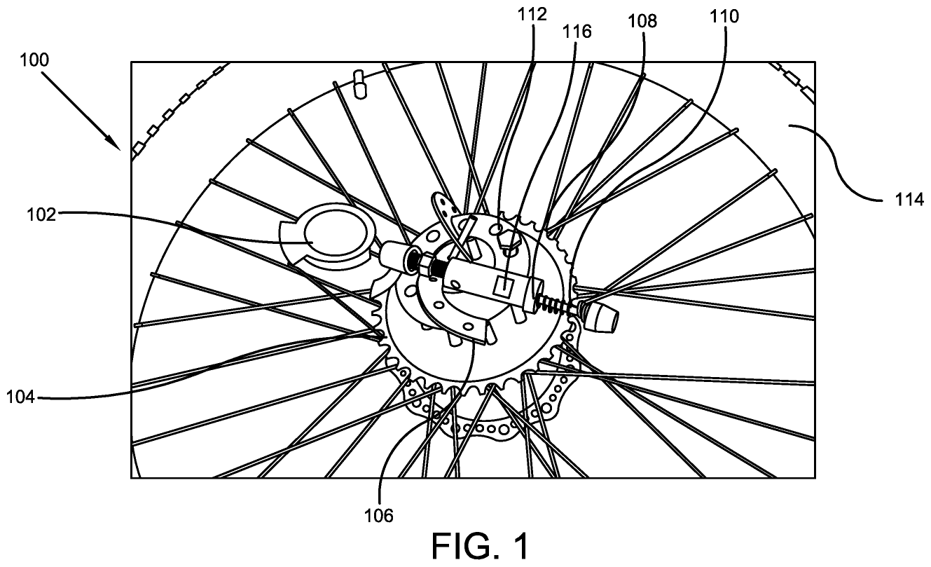

Referring initially to the drawings, FIG. 1 illustrates a perspective view of one potential embodiment of the pneumatic assist device for bicycles of the present invention in accordance with the disclosed architecture. The pneumatic assist device 100 of the present invention is an improved bicycle powering apparatus to create a smoother and more enjoyable riding experience. The device 100 is comprised of a ball bearing gearbox system having a plurality of gears 104,112 wherein an assist arm engages the gears 104 and 112 inside the gearbox system. Specifically, a small gear component 104 is connected to the large gear component 112 through the assist arm. The gearbox system is then attached to the central part of the front wheel 114.

The pneumatic assist device 100 further comprises a swivel component 106 coupled to a pedal bionic assist component 108 via any securing means as is known in the art. The pedal bionic assist component 108 is further comprised of a spring 110 that guides the spiraling up and down motion of the swivel component 106. The pedal bionic assist component 108 also comprises a pneumatic pump 116 to store pressurized air as fuel for the bicycle. The swivel component 106 is used for engaging the pedals of the bicycle through an arm and then the motion of the pedals along with the swivel component 106 allow the pressure of the air in the pneumatic pump 116 to increase. Further, once the device 100 is engaged, the pressure is released powers the front wheel 114 and allows for a smoother ride for the user.

A pulley 102 is also attached to the pedal bionic assist component 108 which allows the device 100 to be attached to a handlebar 302 of a bicycle 300 in use. The device 100 is further connected via a cable 208 to the button/lever on the handlebar 302. Further, the device 100 has a plurality of guides for aligning the gears 104 and 112 of the gearbox system and a plurality of elastic bands which engage the ball-bearings of the gearbox. Thus, the plurality of guides and the plurality of elastic bands act to shift the gears 104 and 112 driving the pneumatic assist device 100 to build air pressure when a user is pedaling. Said pressure is then released when a user activates the pneumatic assist device 100 which in turn powers the front wheel 114.

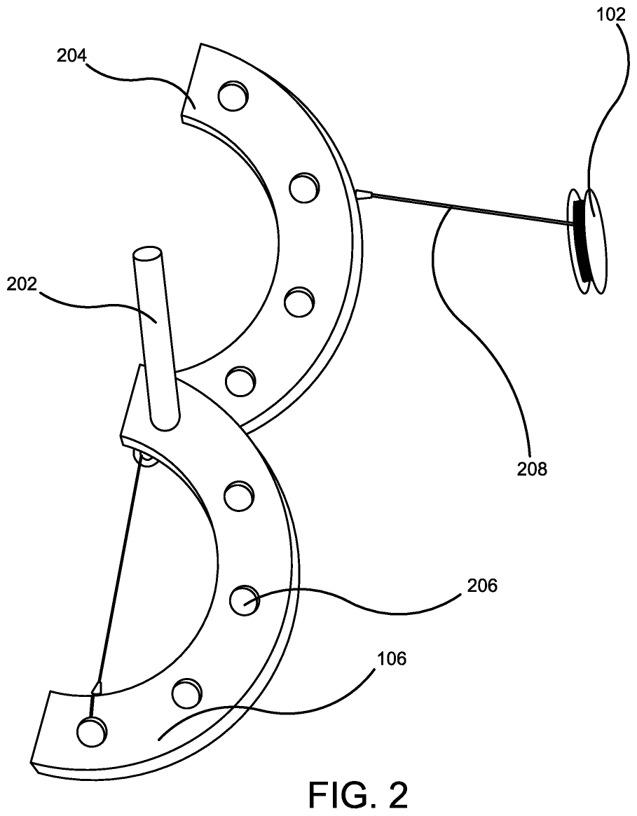

FIG. 2 illustrates a top perspective view of the swivel component 106 and 204 used for retaining the pedal bionic assist component 108 of the pneumatic assist device of the present invention in accordance with the disclosed architecture. Both a first swivel component 106 and a second swivel component 204 are semi-circular shaped and are configured to engage with one another. Each of the first swivel component 106 and the second swivel component 204 also contain a plurality of continuous openings 206 along their surfaces allowing at least one screw or connector 202 to be inserted into the through holes 206 to connect the swivel components 106 and 204 together. Further, the pulley 102 is attached to the second swivel component 204 through a cable 208 which allows coupling of the pulley 102 with the second swivel component 204. Further, one continuous opening 206 of the second swivel component 204 is also used for connecting the second swivel component 204 to the large gear component 112 (shown in FIG. 1). The connector or screw 202 is also used for connecting the pedals 308 of the bicycle with the swivel components 106 and 204.

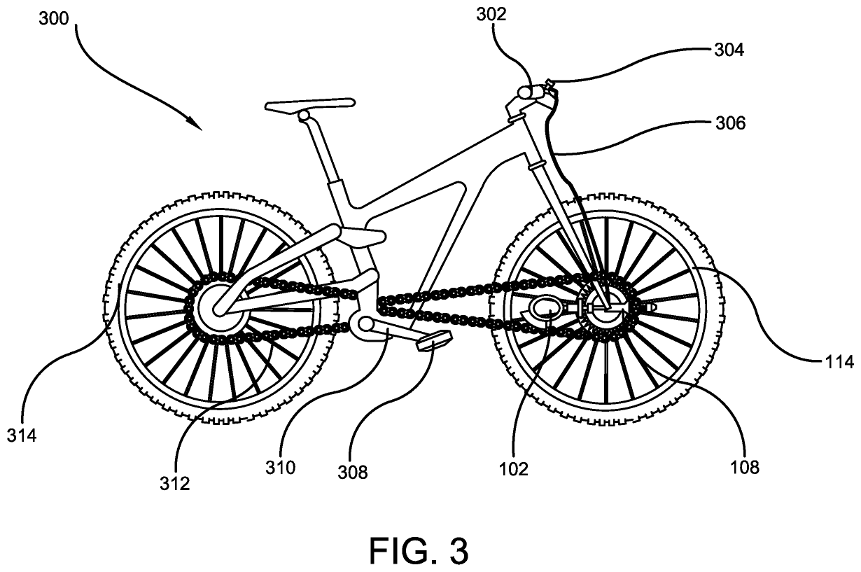

FIG. 3 illustrates a perspective view of a bicycle 300 wherein the pneumatic assist device 100 of the present invention is attached to the front wheel 114 in accordance with the disclosed architecture. Handlebar 302 of the bicycle 300 has a release button 304 to control the pneumatic assist device 100 that is attached to the front wheel 114 of the bicycle 300. A cable 306 further attaches to the pneumatic assist device 100 through the pulley 102 to the release button 304 allowing a user to easily activate the pneumatic assist device 100 which provides pneumatic assistance to the front wheel 114 and allows for a more pleasant ride.

The pedal bionic assist component 108 also assists a rider when the pedals 308 are connected through the crank component 310 and are operated by the user. A chain 312 or alternatively a shaft then allows synchronized movement of the wheels 114 and 314. It should be appreciated that the pneumatic assist device 100 of the present invention can be used with a shaft-driven bicycle that uses a drive shaft instead of a chain to transmit power from the pedals 308 to the front wheel 114.

During use, air pressure is built up within the pedal bionic assist component 108 via the pneumatic pump 116 when a user is pedaling the bicycle 300. Then, when the release button 304 is pushed by a user, the pedal bionic assist component 108 releases the air pressure in the pneumatic pump to propel the pedals 308 faster via powering the front wheel 114 and creating a smoother ride for the user.

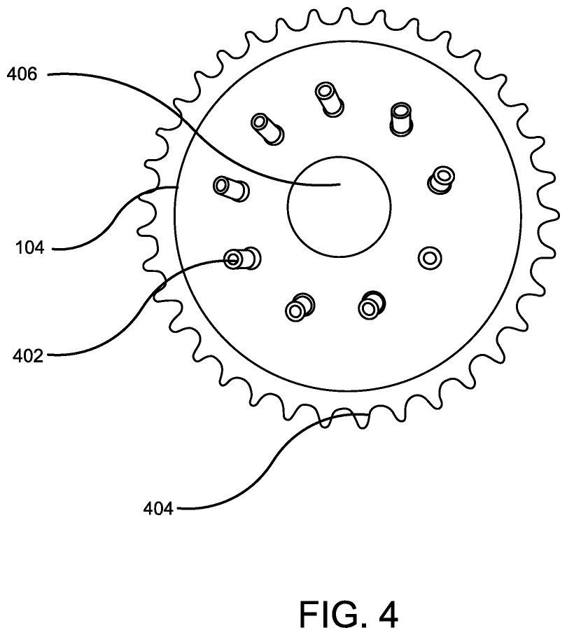

FIG. 4 illustrates a perspective view of the small gear 104 used in the pneumatic assist device 100 and gear box of the present invention in accordance with the disclosed architecture. The small gear 104 has a plurality of retaining members 402 allowing a large gear member 112 to connect to the small gear 104. A central continuous opening 406 can further be used for receiving a diamond shape shaft or any other suitable shaped shaft as is known in the art that secures the large gear 112 component. Further, a plurality of equidistant pointed protrusion members 404 receive a chain of a bicycle to which the pneumatic assist device 100 and gear box of the present invention are engaged. Further, the force applied by movement of the pedals is passed through the chain and allows the gearbox and the pneumatic assist device 100 to provide power and assistance to users of the bicycle.

Accordingly, the device 100 of the present invention eliminates the need for a rider to constantly pedal using the two standard pedals. The device 100 can also be easily activated using a lever and release button on the handlebar 302 of a bicycle 300 which is connected to the gears 104,112 and pedal bionic assist component 108. It should also be appreciated that the pneumatic assist device 100 of the present invention can be used with a wheelchair such that the pneumatic assist device 100 can be attached to the wheels of the wheelchair as well. Therefore, the pneumatic assist device 100 would then provide a smoother ride for the user sitting in the wheelchair.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pneumatic assist device”, “pneumatic assist device for bicycles”, “pneumatic system”, “pneumatic assist device for bicycles” and “device” are interchangeable and refer to the pneumatic assist device for bicycles 100 of the present invention.

Notwithstanding the forgoing, the pneumatic assist device 100 of the present invention can be of any suitable size and configuration as is known in the art without affecting the overall concept of the invention, provided that it accomplishes the above-stated objectives. One of ordinary skill in the art will appreciate that the size, configuration, and material of the pneumatic assist device 100 as shown in FIGS. 1-4 are for illustrative purposes only, and that many other sizes and shapes of the pneumatic assist device 100 are well within the scope of the present disclosure. Although the dimensions of the pneumatic assist device 100 are important design parameters for user convenience, the pneumatic assist device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pneumatic assist device for powering a bicycle, the pneumatic assist device comprising:
a ball bearing gearbox having a plurality of gears;
an assist arm which engages the plurality of gears;
a swivel component; and
a pedal bionic assist component coupled to the swivel component, wherein the ball bearing gearbox is attached to a central part of a front wheel of a bicycle and the swivel component engages a pedal of the bicycle through an arm component, and further wherein motion of the pedal along with the swivel component builds up a pressurized air in the pedal bionic assist component, which once the pneumatic assist device is engaged, releases the pressurized air and propels the front wheel faster.

2. The pneumatic assist device of claim 1, wherein the plurality of gears comprises a small gear component and a large gear component.

3. The pneumatic assist device of claim 2, wherein the assist arm connects the small gear component to the large gear component.

4. The pneumatic assist device of claim 3, wherein the pedal bionic assist component comprises a spring which guides a spiraling up and down motion of the swivel component.

5. The pneumatic assist device of claim 4, wherein the pedal bionic assist component comprises a pneumatic pump to store the pressurized air for the bicycle.

6. The pneumatic assist device of claim 5 further comprising a pulley that is attached to the pedal bionic assist component and secures the pneumatic assist device to a handlebar of the bicycle.

7. The pneumatic assist device of claim 6, wherein the pneumatic assist device is connected via a cable to a button on the handlebar.

8. The pneumatic assist device of claim 7 further comprising a plurality of guides for aligning the small gear component and the large gear component.

9. The pneumatic assist device of claim 8 further comprising a plurality of elastic bands which engage a plurality of ball-bearings of the ball bearing gearbox.

10. The pneumatic assist device of claim 9 further comprising a second swivel component, wherein both the swivel component and the second swivel component are semi-circular in shape and comprise a plurality of continuous openings.

11. The pneumatic assist device of claim 10, wherein at least one screw is inserted into one of the plurality of continuous openings to connect the swivel component to the second swivel component.

12. The pneumatic assist device of claim 11, wherein the at least one screw is used for connecting the pedal of the bicycle with the swivel component and the second swivel component, and for connecting the second swivel component to the large gear component.

13. The pneumatic assist device of claim 12 further comprising a pulley attached to the second swivel component through a cable which allows coupling of the pulley with the second swivel component.

14. A pneumatic assist device which acts to power a bicycle having a front wheel and a pair of pedals, the pneumatic assist device comprising:
a ball bearing gearbox comprising a plurality of gears;
an assist arm which engages the plurality of gears;
a swivel component; and
a pedal bionic assist component coupled to the swivel component, wherein the ball bearing gearbox is attached to a central part of the front wheel of a bicycle and the swivel component engages at least one of the pair of pedals of the bicycle through an arm component, and further wherein motion of the pair of pedals along with the swivel component builds up a pressurized air in a pneumatic pump which, once the pneumatic assist device is engaged, releases the pressurized air to propel the front wheel faster, and still further wherein a handlebar of the bicycle has a release button to control the pneumatic assist device and a cable that attaches the pneumatic assist device through a pulley to the release button to allow a user to activate the pneumatic assist device.

15. The pneumatic assist device of claim 14, wherein the bicycle is a shaft-driven bicycle that uses a drive shaft instead of a chain to transmit power from the pair of pedals to the front wheel.

16. The pneumatic assist device of claim 15, wherein the plurality of gears comprises a small gear component and a large gear component.

17. The pneumatic assist device of claim 16, wherein the small gear component has a plurality of retaining members allowing the large gear component to connect to the small gear component.

18. The pneumatic assist device of claim 17, wherein the small gear component comprises a central opening for receiving a diamond shaped shaft that retains the large gear component.

19. The pneumatic assist device of claim 18, wherein the small gear component and the large gear component comprise a plurality of equidistant pointed protrusion members which receive a chain of a bicycle to which the pneumatic assist device and gear box are engaged, thus force applied by movement of the pair of pedals is passed through the chain and allows the gearbox and the pneumatic assist device to provide power and assistance to a user of the bicycle.

20. A pneumatic assist device which acts to power a wheelchair, the pneumatic assist device comprising:
a ball bearing gearbox comprising a plurality of gears;
an assist arm which engages the plurality of gears;
a swivel component; and
a bionic assist component coupled to the swivel component, wherein the ball bearing gearbox is attached to a central part of a front wheel of the wheelchair and the swivel component engages a wheel of the wheelchair through an arm component, and further wherein motion of the wheel along with the swivel component builds up a pressurized air in a pneumatic pump and a release button positioned on the wheelchair allows a user to activate the pneumatic assist device.
